(19) United States
(12) Patent Application Publication
(10) Pub. No.: US 2018/0284453 A1
(43) Pub. Date: Oct. 4, 2018

(54) CUSTOMER INTERACTION SYSTEM

(71) Applicant: Walmart Apollo, LLC, Bentonville, AR (US)

(72) Inventors: Leslie Irvin, Gravette, AR (US); Yurgis Mauro Bacallao, Centerton, AR (US)

(21) Appl. No.: 15/941,120

(22) Filed: Mar. 30, 2018

Related U.S. Application Data
(60) Provisional application No. 62/480,949, filed on Apr. 3, 2017.

(51) Int. Cl. G02B 27/01; G06T 19/00; G06Q 30/06; G06Q 10/06; H04W 4/021

(52) U.S. Cl. CPC G02B 27/0172; G06T 19/006; G06Q 30/0641; G02B 2027/0178; G06Q 10/06398; H04W 4/021; G06Q 30/0633

(57) ABSTRACT

A system that may transmit the customer data for each customer client device entering the geofence having a shopping application and profile accessible to the store's computer network to an augmented reality device. Each of the augmented reality devices may be worn by a sales associate or other employee of the store. The augmented reality devices may take the shape of any computing device, but in the exemplary embodiment the augmented reality device may be in the form of glasses or eyewear. While wearing the glasses or eyewear, the store's sales associate or employee may view customer data transmitted over the stores computer network while simultaneously viewing the physical world. The augmented reality device may present the data in the form of a heads up display (HUD), allowing the associate to know details about the customer entering the store before engaging in a conversation with the customer.

### CROSS REFERENCE TO RELATED APPLICATION

This invention claims priority to U.S. provisional patent application Ser. No. 62/480,949 filed Apr. 3, 2017 entitled “Customer Interaction System”, which is incorporated entirely herein by reference.

### TECHNICAL FIELD

The present disclosure relates generally to systems, methods and tools for providing customer service using augmented reality.

### BACKGROUND

Service industries, sales industries and employees thereof, are responsible for assisting customers and clients who seek out to receive goods and services a particular vendor. Often, it is recognized in the service and sales industries, establishing a relationship with customers can lead to increased trust between the customers and employee and ultimately lead to increased sales. One way to increase the relationship between a vendor and the customer is for the salesmen or employee of the vendor to increase their own personal knowledge and facts about the customer in order to be prepared to provide the most knowledgeable advice. Moreover, a salesman with a greater knowledge of the customer may be more successful in offering the right products or services that the customer will appreciate.

### SUMMARY

A first embodiment of the present disclosure provides a method for a method for assisting a customer comprising the steps of: detecting, by a computer system, a client device of the customer entering a geofence established by the computer system; monitoring, by the computer system, a location of the computing device within the geofence; retrieving, by the computer system, customer data from a user profile loaded in a memory device of the computing device; overlaying, by the computer system, the customer data onto an augmented reality display device as a function of the location of the computing device being within a visible distance of the augmented reality display; further overlaying, by the computer system, a customer service guide onto the augmented reality display device, guiding how to assist the customer within the visible distance of the augmented display device; and dynamically updating, by the computer system, the customer data as a function of assisting the customer.

A second embodiment of the present disclosure provides a computer system comprising a processor; a memory device coupled to the processor; an augmented display device placed into wireless communication with the processor, the augmented display device having a heads up display; and a computer readable storage device coupled to the processor, wherein the storage device contains program code executable by the processor via the memory device to implement a method for assisting a customer comprising the steps of: detecting, by a computer system, a computing device entering a geofence established by the computer system; monitoring, by the computer system, a location of the computing device within the geofence; retrieving, by the computer system, customer data from a user profile loaded in a memory device of the computing device; overlaying, by the computer system, the customer data onto an augmented reality display device as a function of the location of the computing device being within a visible distance of the augmented reality display; further overlaying, by the computer system, a customer service guide onto the augmented reality display device, guiding how to assist the customer within the visible distance of the augmented display device; and dynamically updating, by the computer system, the customer data as a function of assisting the customer.

### BRIEF DESCRIPTION OF THE DRAWINGS

FIG. 1 depicts a block diagram of an embodiment of a system for assisting a customer.

FIG. 2a depicts an isometric view of an embodiment of an augmented reality display device.

FIG. 2b depicts a front view of the embodiment of the augmented reality display device of FIG. 2a.

FIG. 2c depicts a side view of the embodiment of the augmented reality display device of FIG. 2a,

FIG. 3 illustrates an embodiment of an augmented reality display device equipped by a user.

FIG. 4 depicts a first person view of a user viewing a heads up display (HUD) of an augmented reality device.

FIG. 5 depicts a first person view of a user viewing an external environment through an embodiment of an augmented reality device.

FIG. 6 depicts a top-down view of an embodiment of a store implementing a system for assisting a customer consistent with the figures and descriptions of the present disclosure.

FIG. 7 depicts an embodiment of an algorithm for assisting a customer consistent with the systems, devices, methods and tools described throughout the present disclosure.

FIG. 8 depicts a block diagram of a computer system able to implement the methods for assisting a customer consistent with the disclosure of the present application.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

### Overview

Traditionally, a gap has existed between online shopping and shopping in the physical world. In the realm of online shopping, powerful tools exist that allow for users to make purchases remotely, in the comfort of the user's home. Computer systems providing the content to the user as the user shops using the Internet, may utilize data analytics to analyze the user's behavior, track user activity and purchasing habits to allow for suggestions to be made to the user over the online shopping portal. Conversely, in the physical world, vendors, stores, and employees thereof learn about customers' needs and wants through active conversations between the employees and customers. Employees may be taught to engage customers, listen to the customers' needs and then address the needs by offering solutions and assistance based on the active conversation that has occurred.

Under currently available systems, the separation between the online shopping space and the shopping space of the physical world limits the amount of data and insight an employee or salesmen may have available at their fingertips when meeting a customer for the first time. Currently available systems lack the ability for an employee or sales person to naturally obtain and inconspicuously view customer information collected over the course of the customer's online shopping experience while simultaneously interacting with the customer directly in the physical space of a store. The lack of immediately accessible information about the customer and the customer's preferences may place the salesmen or employee at a disadvantage while first engaging a customer in a physical setting. Being able to access information collected by online shopping systems that have already interacted with the customer in the past would allow for the salesmen in the physical space to better understand the customer, engage the customer and provide quality customer service, in a more efficient manner.

The embodiments of the present disclosure leverage computing networks, online shopping systems, data collection and augmented reality systems in order to merge data collected during an online shopping experience by a customer with direct physical interactions that a customer may experience while shopping in a physical store. Employees or salesmen interacting with the customer in the physical store may be able to simultaneously view both the customer and customer data collected about the customer during the customer's online shopping experience. By viewing both the customer's data and speaking directly with a customer, the employee or salesmen may be able to target the needs of the customers more efficiently, make more concise recommendations based on the customer's purchasing habits, assist the customer with finding items within the store or ordering items that may not be carried by the store and provide an unprompted status update about a customer's pickup order previously placed online, all the while maintaining proper customer service protocol and eye contact with the customer.

Embodiments of the disclosed systems may bridge the gap between online shopping and physical shopping through the use of computer applications or programs that may be used by both the customer on the customer's client computing device and be accessible to a computer network maintained by the physical store location. The application or program loaded onto the customer's client device may store and save the customer's data as the customer uses the application to perform shopping functions. For example, the customer may perform one or more actions using the application, such as browsing and select merchandise for purchase, creating shopping lists or wish lists, scheduling a pharmacy order, creating an order to be picked up at a physical store, rating one products, or any other function that may be available and known by a person skilled in the art. As the customer performs each of these functions, the application may save or track the customer's actions in a customer's profile and maintain the customer profile on the application's server which may be responsible for distributing the content of the application to the customer.

A client device loaded with the shopping application may interact with a physical store's computer network. The client device communicating with the store's computer network may divulge the identity of the customer via the customer's profile, allowing for the one or more computer systems on the network to retrieve the customer's data stored by the customer's profile from the application server. The customer may set permissions for the store to retrieve and access the customer data generated by the shopping application. In some embodiments, the retrieval of the customer's profile may be performed as a function of the customer's proximity to the physical store and/or the physical store's network. Embodiments of the system, may establish a geofence around a store's location, monitoring the presence of client devices entering, exiting or dwelling within the geofence of the store. For example, the customer's client device may use a global positioning system (GPS) or a Wi-Fi positioning system (WPS) of the store to geolocate the position of the client device in relation to the store's location. As the client device's geolocation intersects with the virtual boundary of the store, the client device may be identified to the store's computer network, triggering the computer network of the store to access the customer's profile and retrieve customer data from the application server storing the customer data.

In some embodiments of the system, the geofencing system set up by the store's computer network may transmit the customer data for each customer client device entering the geofence that has the shopping application and profile accessible to the store's computer network to one or more augmented reality display devices. Each of the augmented reality display devices may be worn by a sales associate or other employee of the store. Embodiments of the augmented reality display devices may take the shape of any computing device, but in the exemplary embodiment the augmented reality device may be in the form of glasses. While wearing the glasses, the store's sales associate or employee may view customer data transmitted over the stores computer network while simultaneously viewing the physical world. The augmented reality display device may present the data in the form of augmented reality positioned on a heads up display (HUD) that may display the customer service data of a particular customer when the customer is viewed through the lenses if the augmented reality display device. When viewing the physical world through the augmented reality display device, the employee or associate of the store may view customer data stored by the customer's profile, overlaid onto the physical world. As the associate or employee of the store comes into viewing distance of the customer (equipped with the client device which may be transmitting geolocation) the sales associate may engage the customer, ask to assist the customer and utilize the customer data being viewed through the augmented reality display device to provide a better customer service experience, by tailoring the interaction to the customer's specific needs based on the customer data displayed by the augmented reality display device.

In some embodiments of the system, the customer service experience may be further enhanced by providing additional supplemental information and guidance to the augmented reality display device of the HUD by the augmented reality display device. In some embodiments, the computer network of the store or enterprise may have access to additional knowledge bases, databases and data sources beyond the customer data being provided by the application data server of the customer's shopping application. For example, the computer network may save and maintain a knowledge base, databases and repositories comprising retail store data describing an ideal set of customer service procedures and protocols for interacting with customers entering the store (standard operating procedures for customer engagement), the types of services offered by the store, employee staffing information and employee assignments. The store's computer network may transmit notes, reminders and steps for interacting with customers directly to the augmented reality devices. As the store associates and salesmen engage and interact with each customer, reminders of the best practices and guidelines of the stores customer service protocol according to the standard operating procedures may be displayed by the HUD for the store associate to follow. Additionally, as the employee interacts with the customer, the HUD may further display a list of suggested services that may be applicable to the customer as well as identify opportunities to upsell the client on a particular product or service offered by the store.

In some embodiments, the augmented reality device may be equipped with a recording system such as a camera or microphone for storing the conversation between the store's associate and customer. The recorded data may be streamed over the computer network. In some embodiments of the system, the audio conversations and video recordings may be parsed and analyzed by an analytics or inference engine which may draw conclusions about the conversation between the sales associate and the customer. Based on the conclusions drawn by the analytics module or inference engine, the system may dynamically update the guideline and protocol reminders displayed by the augmented reality device. Moreover, in some embodiments of the system, the recording system may store the audio and video recordings for teaching tools or evaluation tools. The recordings may demonstrate how a sales associate should or should not engage with a customer and/or be used to evaluate whether or not the sales associate properly followed customer service guidelines established by the store, enterprise or corporate offices.

### System for Assisting Customers

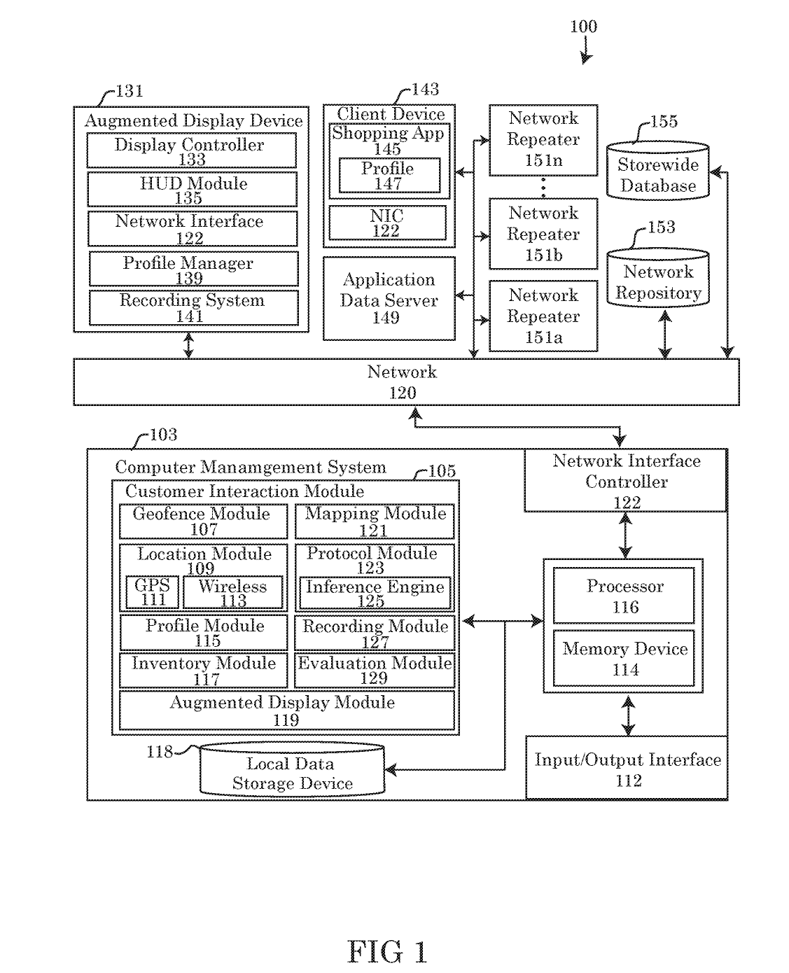

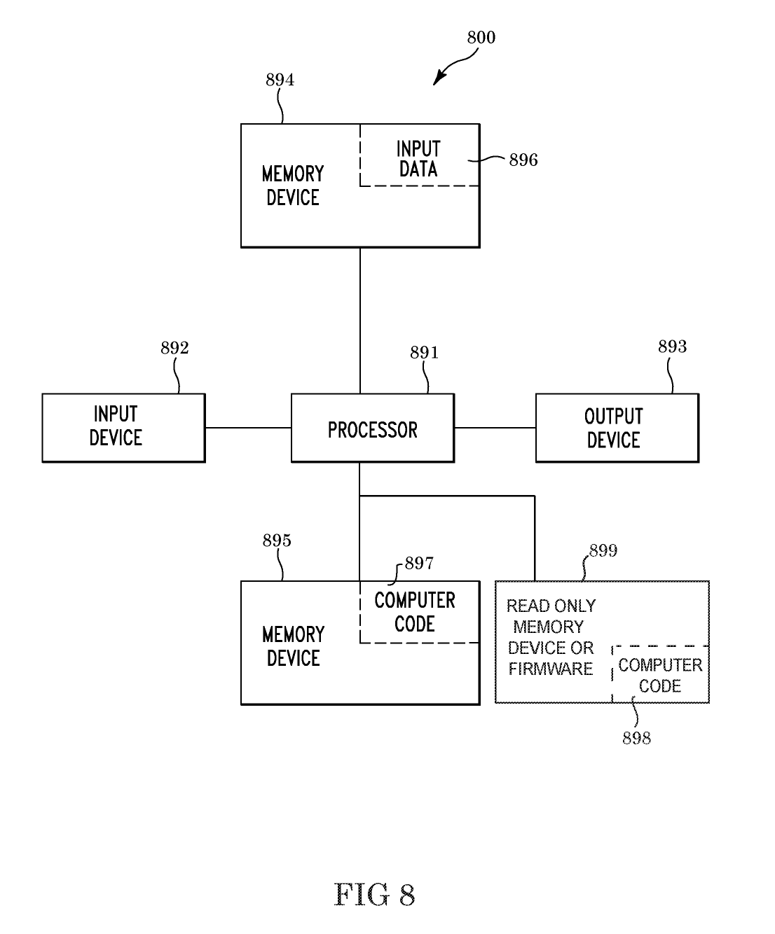

Referring to the drawings, FIG. 1 illustrates a diagram of an embodiment of a system 100 for assisting customers, consistent with the disclosures of this application. Embodiments of systems 100 may comprise one or more specialized computer systems 103, 131, 143, 149, 151 each having a specialized configuration of hardware, software or a combination thereof as depicted in FIGS. 1-6 and as described throughout the present disclosure. Embodiments of the computer systems 103, 131, 143, 149, 151 may further comprise one or more elements of the generic computer system 800 of FIG. 8, described in detail below. The elements of the generic computer system 800 may be integrated into each of the specialized computer systems 103, 131, 143, 149, 151 described herein.

Embodiments of the computer systems 103, 131, 143, 149, 151 may be a specialized computer system which may include one or more processors 116, specialized hardware or circuitry and/or software loaded in the memory device 114 of the computer systems 103, 131, 143, 149, 151. The embodiments of the computer systems 103, 131, 143, 149, 151 may perform functions, tasks and routines relating to the establishment of geofences, identifying the location of each customer via the customer's client device, customer profile and customer data management, transmission and display of customer data, customer service protocols which may be in accordance with a store's standard operating procedures, store services, upselling suggestions, and employee and staffing information which may each be provided to an augmented reality display device. The augmented reality display device may be recording and analyzing customer interactions in accordance with the standard operating procedures (SOPs) defining the customer engagement process, and evaluating the customer service interactions for compliance with the SOPs.

Embodiments of the computer systems 103, 131, 143, 149, 151, may be connected and placed in communication with one another as well as additional computer systems or hardware, over a computer network 120. Embodiments of the network 120 may be constructed using wired or wireless connections between each hardware component connected to the network 120. As shown in the exemplary embodiment of FIG. 1, each of the computer systems 103, 131, 143, 149, 151 incorporated into the network 120 may connect to the network 120 and communicate over the network 120 using a network interface controller (NIC) 122 or other network communication device. Embodiments of the NIC 122 may implement specialized electronic circuitry allowing for communication using a specific physical layer and a data link layer standard, such as Ethernet, Fiber channel, Wi-Fi or Token Ring. The NIC 122 may further allow for a full network protocol stack, enabling communication over network 120 to the group of computer systems or other computing hardware devices linked together through communication channels. The network 120 may facilitate communication and resource sharing among the computer systems 103, 131, 143, 149, 151 and additional hardware devices connected to the network 120, for example a network accessible data repository 153 or other network accessible storage devices connected to the network 120. Examples of network 120 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

Embodiments of the system 100, and functions performed by the computer systems connected to the computer network 120 may be managed and controlled by a computer management system 103. The computer management system 103 may operate as a central node on the network 120 and may be responsible for creating the geofence around the store, tracking the location of client devices 143 entering the geofence, tracking the locations of augmented reality devices 131, retrieving customer data stored by the customer's profile 147, from one or more web servers or application data servers 149 and transmitting the customer data to each augmented reality display device 131, managing data recorded during the customer interactions between customers and associates, as well as providing supplementary support data to the augmented reality display devices 131 such as inventory data and mapping data for the store.

Embodiments of the computer management system 103 may include specialized hardware and/or software integrated into the computer management system 103 performing each of the functions of the computer management system relating to geofences, location data, profile management, inventory management, mapping, customer service protocol, recording, associate evaluations and management of augmented reality display devices. The specialized components of the computer management system 103, implementing each function or task may be part of a customer interaction module 105. The hardware and/or software components of the customer interaction module 105 may include one or more sub modules in some embodiments. These sub modules may include a geofence module 107, location module 109, profile module 115 inventory module 117, augmented display module 119, mapping module 121, protocol module 123, recording module 127 and evaluation module 129. As used herein, the term “module” may refer to a hardware module, software-based module or a module may be a combination of hardware and software resources of a computer system and/or resources remotely accessible to the computer system via the computer network 120.

Embodiments of the modules described in this application, whether comprising hardware, software or a combination of resources thereof, may be designed to implement or execute one or more particular functions, tasks or routines of the computer system computer management system 103 described herein. Embodiments of hardware-based modules may include self-contained components such as chipsets, specialized circuitry and one or more memory devices comprising a memory storage medium (described below). A software-based module may be part of a program code or linked to program code or computer code 897, 898 containing specific programmed instructions loaded into a memory device 114 of the computer management system 103, and/or a remotely accessible memory device 114 of a network accessible computer system 131, 143, 149 accessed remotely over the network 120. For example, in some embodiments the network accessible computer system connected to computer system 103 may be a web server, application server 149, client device 143, augmented reality display device 131 or network accessible hardware such as a network repeater 151a, 151b . . . 151n (hereinafter network repeater 151), network repository 153 or a storewide database 155.

Embodiments of the computer management system 103 may include a geofence module 107 which may be part of the customer interaction module 105. The geofence module 107 may be responsible for performing the tasks or functions of creating, monitoring and deleting geofence locations. A geofence may refer to a virtual geographic boundary which may be defined by a GPS, RFID, Wi-Fi, Bluetooth, or other locational positioning technologies. A created geofence enables software to trigger a response or event when a computer system enters the geofence, exits the geofence or dwells within the geofence for a predetermined length of time. Embodiments of a geofence module 107 may establish a geofence boundary around the perimeter of a store housing the computer network 120 and/or the computer management system.

Embodiments of the geofences created by the geofence module 107 may be used to trigger the identification of client devices 143 entering a store surrounded by the geofence, initiate the retrieval of identifying customer profile information stored by the client device 143 and further allow for the computer management system 103 to utilize the customer profile information to retrieve customer data from a web server or application server 149 storing the customer data. For example, a customer arriving at the store may have a client device 143, such as a smart phone, cell phone, tablet computer laptop or other mobile computing device with them. The client device 143 may be equipped with a shopping application 145 affiliated with the store the customer has arrived at and may store customer data to a profile 147. The customer may set permission to the shopping application 145 to communicate the profile 147 data to the affiliated store. As the customer enters the store, the customer may cross the geofence boundary which may trigger a series of identifying events, namely the connection of the client device to the network 120 and the identification of the customer via the profile 147 loaded onto the memory the of client device 143's shopping application 145.

Embodiments of the computer management system 103 may track the location of client devices 143 as well as augmented reality display devices 131 within range of the network 120 and the geofence. The location module 109 may be responsible for keeping track of the movement and position of client devices 143 and augmented reality display devices 131 proximate to the store and within the store. In some embodiments of the system 100, location module 109 may collect location data being broadcasted by each client device 143 and/or augmented reality display device 131. Location data collected by the location module 109 may be stored by the computer management system 103 in a local data storage device 118 or remotely on the network 120 in a network accessible data repository 153.

Embodiments of the location module 109 may be able to identify the locations of client devices and augmented reality display devices 131 using multiple types of location technologies. Embodiments of the location module 109 may use long range location technologies such as GPS tracking or cell tower triangulation. Long range location technologies may be useful for identifying the location of the customer's client device 143 while the client device 143 is outside of the range of the stores computer network 120. In the exemplary embodiment of the system of FIG. 1, the location module 109 may include a GPS tracking module 111 which may communicate with GPS satellites to send and receive coordinates of client devices 143 using the client device's 143 onboard GPS antenna.

Alternatively, for a more precise location tracking, particularly indoors, short range location tracking hardware may be incorporated into the computer management system 103 through a wireless tracking module 113. Under the computer network 120 may use wireless tracking or beacons to locate the position of client devices 143 and augmented reality display devices 131 inside a location and/or within a geofence established by the geofence module 107. In some embodiments, the short range wireless tracking may include Wi-Fi positioning, Bluetooth, Bluetooth LE, RFID, infrared or other radio wave based systems. In the exemplary embodiment, the locations of client devices 143 and augmented reality display devices 131 may communicate with the network 120 over a Wi-Fi connection using a Wi-Fi positioning system (WPS). The distance between the Wi-Fi waves being sent and received by each client device 143 or augmented reality display device 131 may indicate the distance of each device from the Wi-Fi access point. For a more accurate positioning, a plurality of network repeaters 151 may be positioned throughout a store or other location. The emission of the Wi-Fi from the access point and each repeater 151 may be used to triangulate the approximate position of the client device 143 or the augmented reality display device 131 interacting with each set of Wi-Fi waves received by the client device 143 or the augmented reality display device 131.

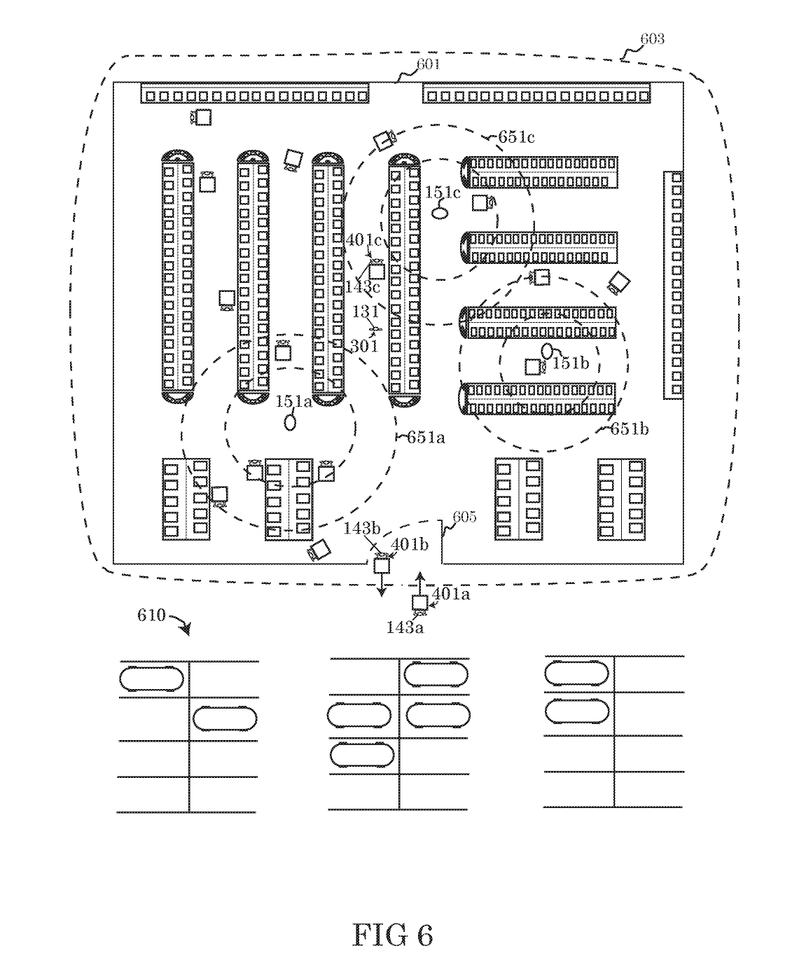

Referring to the drawings, FIG. 6 provides an example of using a combination of geofencing and wireless location tracking to identify the positions and movements of customers 401a, 401b, 401c entering and dwelling within a geofence 603 surrounding store 601. As depicted in the drawing, each customer 401a, 401b, 401c may be equipped with a client device 143a, 143b, 143c sending and receiving location data to the location module 109 of the computer network 120. Each customer 401 being depicted in the drawing may be considered to be within a different state of the geofence 603. For example, customer 401a is depicted as entering the geofence 603. The customer 401a is moving from the exterior side 610 of the geofence 603 across the geofence boundary 603. While on the exterior side 610 of the geofence 603, the customer 401a may be tracked over a long range tracking system such as GPS. As customer 401's associated client device 143a enters the range of the network 120 and/or crosses the geofence boundary 603, the computer management system 103 may switch location tracking modes from the GPS module 111 to the wireless module 113 as the customer's 401a client device 143a connects to the network 120.

Conversely, customers 401b is shown to have been previously inside store 601 which is encompassed by the geofence 603. While within the boundaries of the geofence 603, the location of the customer's 401b client device 143b may have been tracked by the broadcasting access points of the network 120 delivering location data to the wireless tracking module 113. As the customer 401b moved throughout the store 601, the network's repeaters 151a, 151b, 151c amplifying the signal of the network's 120 wireless signal may use Wi-Fi or another short range wireless signal to position the customer 401b using the wireless antenna of the client device 143b. As shown in the drawing, each network repeater 151a, 151b, 151c may be placed in a different location throughout the store 601. Each network repeater 151 may emit wireless signals 651a, 651b, 651c from the network repeater 151 antenna. The amount of time it takes for the customer's 401b client device to receive the wireless signal 651a, 651b, 651c from each network repeater may allow for the wireless tracking module 113 to map the position of the customer 401b within the store. However, as customer 401b exits through the door 605 of the store 601, the customer's 401b client device 143b exits the geofence 603. The event of leaving the geofence 603 may cause the network 120 to switch tracking modes from the wireless tracking mode to a long range tracking mode, such as GPS, as the location module 109 continues to collect location data from customer 401b.

Similar to customer 401b, customer 401c equipped with client device 143c remains within the geofence 603. While inside the geofence, customer 401c's position may be tracked by the wireless network based on the relative position of the customer 401c to each of the network repeaters 151 positioned throughout the store. The wireless signals 651a, 651b, 651c may be emitted from each network repeater 151 at a constant rate. Thus, the wireless module 113 may calculate the position of customer 401c based on the timing and order in with the wireless signals 651 of each network repeater reach client device 143c. As shown in FIG. 6, it can be see that wireless signals 651c emitted from network repeater 151c are closest to the client device 143c. Subsequently, depending on the amount of time it takes for wireless waves 651a and 651b to reach the client device 143c, the wireless module can determine the customer's 401c position. As the customer moves throughout the store, the timing of client's device 143c receiving each set of wireless signals 651 may change, thus a change indicating a change in the customer's 403c position relative to the emitted signals 651.

Referring back to FIG. 1, embodiments of the customer interaction module 105 of system 100 may include a profile module 115. The profile module 115 may be responsible for performing the tasks and functions of managing each of the profiles 147 corresponding to the client device 143 entering the geofences created by the geofence module 107. The profile module 115 may identify the profile 147 loaded onto the client device 143 by receiving profile identification information from the client device 143 and subsequently querying a web server or application server 149 for the profile data corresponding to the identified profile 147. The profile module 115 may load the customer data corresponding to the queried profile 147 into the memory device 114 of the computer management system 103 for transmission of the customer data of the profile to an augmented reality display device 131 via the network 120 by the augmented display module 119.

Embodiments of the profile module 115 may, in some embodiments, further format and maintain the customer data of the customer profiles 147 in one or more data repositories 118, 153 or databases 155 that may be either locally accessible or accessible over the network 120. By storing customer data in one or more data repositories 118, 153 or databases 155, the profile module 115 may quickly load customer profiles 147 and may periodically update the customer data by regularly checking the web server or application data server 149, retrieving the updated customer data and transmitting the updated customer data to the augmented reality display device 131 via the augmented display module 119. Furthermore, in some embodiments, changes to the customer data may be made by the profile module 115 and requests to alter the customer data stored by the profile 147 on the web server or application server 149 may be updated in accordance with the modified customer data uploaded to the server by the computer management system 103.

In some embodiments of the computer management system 103, the customer interaction module 105 may comprise an inventory module 117. The inventory module 117 may perform the task and function of tracking storewide inventory of products available for purchase, the locations of products within the store as well as the inventory of products available at other stores of an enterprise's chain of stores. Embodiments of the inventory module 117 store the information about a store's inventory as inventory data in an onboard memory device of the inventory module 117, a local data storage device 118 or a network accessible storage device, such as the network repository 153.

The inventory module 117 may receive queries about the location and availability of inventory at the store from one or more sales associates, employees or customers. In response to a query request about a specific item or product of inventory, the inventory module 117 may query an inventory database, table or other data structure tracking the store's or enterprise's inventory such as the storewide database 155. The inventory module 117 may return the results of the query to sales associate, employee or customer making the request. For example, a sales associate assisting a customer may receive a question about the availability of a specific product. The sales associate may transmit the query from the sale's associate's augmented reality display device 131 over the network 120 to the computer management system 103. In response to the query request, the inventory module may search the inventory database, table or data structure, retrieve the results and transmit the results to the augmented reality display device 131, allowing for the sales associate to inform the customer of the status of the requested inventory information. In an alternative example, the request for information about the inventory of the store may be made by a client device 143 connected to the network 120. Under such circumstances, the inventory module may perform the query, receive the results, but instead of transmitting the results to the augmented reality display device 131, the inventory module 117 may transmit the results of the inventory query back to the client device 143.

Embodiments of the computer management system 103 may further comprise a mapping module 121. The mapping module 121 may create, store, update and transmit one or more mappings of locations, such as the layout of a particular store to the augmented reality display device 131 or client device 143 over the network 120. The mapping module 121 may plot the locations of products carried by the store onto a map viewable to sales associates on the augmented reality display device 131 or directly to the customer's client device. The mapping module 121 may use the inventory module's inventory data describing the availability and locations of inventory within a store or enterprise to build the maps. Once the location of the products has been identified by the mapping module 121, the mapping module may plot the locations of the products onto a map or user interface viewable on the HUD 210 of the augmented reality display device 131 or a display device of the customer's client device 143 so that sales associates or customers may view the location of requested products.

In some embodiments, the mapping module 121 and the location module 109 may work together to provide a fully interactive map that may provide the location of the products, location of requester performing the query and tracking the movements of the requestor in real time on a mapping interface tracking the requester' progress as the requester moves through the store toward the product location, or further from the product location. In the exemplary embodiment, the map of the store 407 and accompanying product locations 411 may be provided to an augmented reality display device 131 and displayed on a HUD 210 of the augmented reality display device 131. The map may depict the current location 409 of the sales associate in relation to product locations 411 and track the progress of the sale's associates movement toward the product location 411. By projecting the locations of products of interest onto the map 407, the sales associate can seamlessly and accurately guide a customer to the products without becoming lost or inadvertently misguide the customer to an incorrect location.

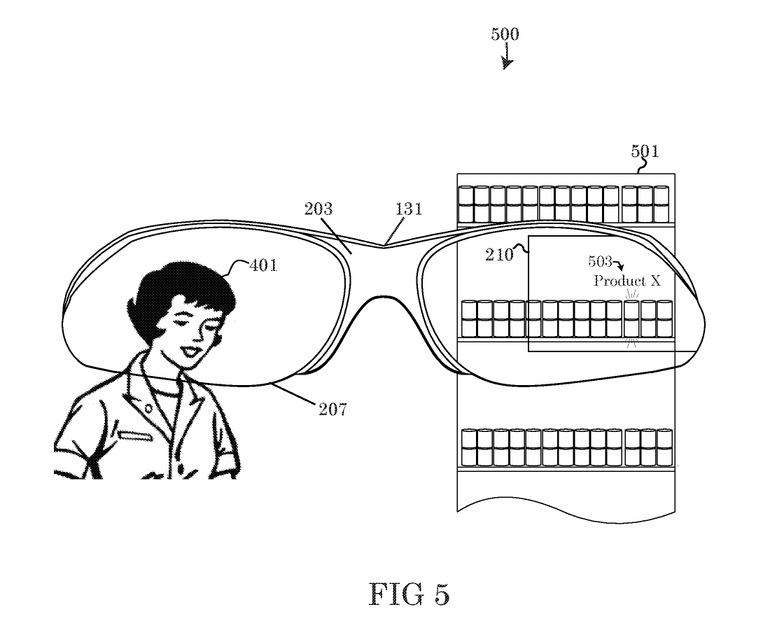

In another example shown in FIG. 5, the augmented reality display device 131 may utilize the augmented reality of the HUD to more easily identify a specific product 503 amongst the store's inventory. As shown in the example of FIG. 5, a user of the augmented reality display device 131 may more easily identify a requested product by using the HUD 210 to highlight or accentuate to desired product among other products displayed on the store shelves, allowing for a sales associate to more easily find a product 503 at a much quicker glance.

Embodiments of the computer management system 103, the customer interaction module may further comprise a protocol module 123, which may be responsible for creating, retrieving, storing, updating and transmitting customer service guidelines and SOPs from one or more data sources to the augmented reality display device 131. The customer service guidelines may include custom tailored procedures, rules and suggestions for engaging customers, listing available services, interacting with customers, upselling products or services, providing service suggestions and providing customer service to customers. For example, the customer service guidelines may teach sales associates the proper way to greet customers, converse with customers, provide assistance, resolve customer disputes, provide product suggestions, upsell products or services, etc. The customer service guidelines and SOPs may vary depending on the data source of the guidelines. Different franchises, store locations and enterprises may have different opinions on how customer service may be implemented and these differences may be codified in the customer service guidelines and SOPs of a particular business. The customer service guidelines may be stored electronically in the onboard memory of the protocol module 123, locally to a data storage device 118 of computer management system 103 or may be accessible to the computer management system 103 via the network 120 from a network accessible repository 153, storewide accessible database 155 or other data source.

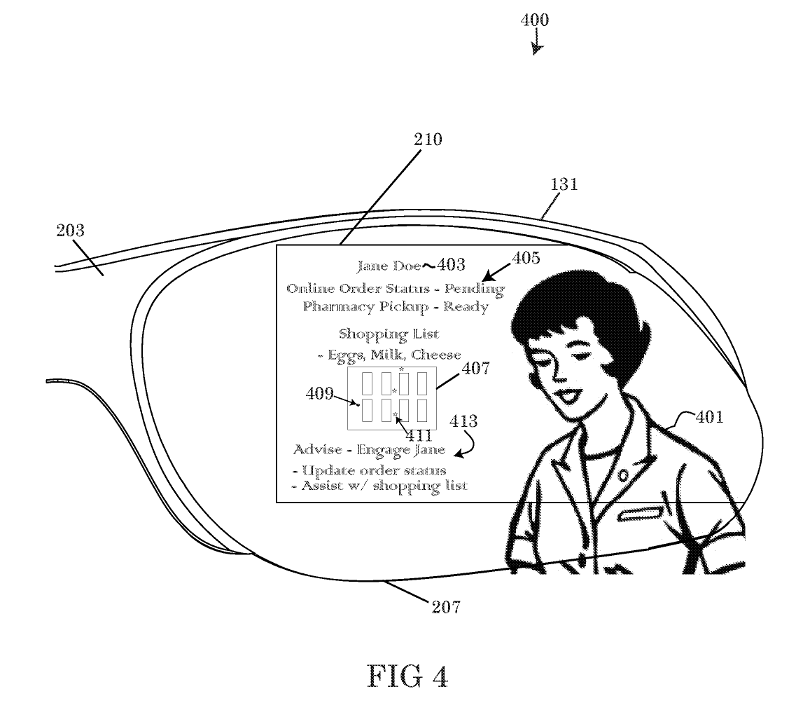

Embodiments of the protocol module 123 may retrieve the customer service guidelines and SOPs from an electronic storage location or data structure and load the customer service guidelines into the memory device 114 of the computer management system 103. The protocol module 123 may transmit situationally appropriate guidelines to a sales associate's HUD 210 as a reminder how to interact with customers or to assist with the sales associate with asking the correct questions of the customer, and to ensure that the sales associate performs the sale's associate's duties in a manner consistent with customer service guidelines and SOPs of the enterprise. In some embodiments, the customer service guidelines and SOPs presented to the sale's associate's HUD 210 may be general reminders of the business's policies on performing quality customer service. In other embodiments, the advice provided by the protocol module 123 to the augmented reality display device 131 may be context specific and/or customer specific depending on the customer the sales associate may be interacting with. For example, in FIG. 4, upon viewing a customer 401, the HUD 210 displays customer service guidelines 413, advising the sales associate to engage the customer 401, a reminder of the services offered by the store, tips or reminders to upsell particular products and services, inform the customer on the status of the customer's 401 orders 405 and to assist the customer 401 with the customer's shopping list.

In some embodiments, the customer service advice provided to the sales associates based on the customer service guidelines and SOPs may be dynamically updated as the conversation between the sales associate and customer progresses. In order to provide and display proper advice on the HUD 210 of the augmented reality display device, the protocol module 123 may be equipped with an inference engine 125. The inference engine 125 may receive context specific information about the sales associate's interaction with the customer, and using the interaction data and customer data, the inference engine may draw conclusions about the appropriate customer service guidelines and SOPs to provide to the HUD 210. The inference engine 125 may be a rules-based system that may guide the conclusions drawn by the inference engine 125.

Embodiments of the inference engine 125 may draw different types of inferences from different conclusion strategies such as forward chaining and backward chaining. A forward chaining strategy occurs where data, such as conversational data recorded by the augmented reality display device, customer data and/or the customer service guidelines, are placed into the memory device 114 of the computer management system 103 or onboard memory of the protocol module 113. As the data is analyzed by the inference engine 125, rules may be triggered whose conditions match the new data, resulting in the performance of an action. The actions may add new data to memory, thus triggering more rules. And so on. This may be referred to called data-directed inference, because inference is triggered by the arrival of new data in working memory. Conversely, a backward chaining methodology, allows for the inference engine to know a value of a piece of data by searching for rules whose conclusions mention the particular piece of data. Before using the rules under a backward chaining strategy, the inference engine may test the conditions which may entail discovering the value of more pieces of data. This may also be called goal-directed inference, or hypothesis driven, because inferences may not be performed until the inference engine 125 proves a particular goal.

Interactions between the customer and sales associate may provide data to the protocol module 123. The inference engine may use the progression of the conversation as data to draw conclusions about providing better customer service to the customer based on the conversation which may be recorded by a recording system 141 on the augmented reality display device 131 and parsed by the inference engine 125 for clues about the conversation. The conversational data, customer service data of the customer's profile when viewed in light of the customer service guidelines may allow for the inference engine 125 to draw conclusions on how to better service the customer.

For example, a sales associate may engage in a conversation with a customer after viewing customer data on a HUD 210 of an augmented reality display device 131 informing the store's associate that the customer's online order is ready for pickup. Based on the customer data, and customer service guidelines, the inference engine may draw the conclusion that the associate should inform the client that the pickup order is ready and thus remind the associate to offer the pickup status to the customer. In another example, the conversation between the associate and customer may lead into the customer asking about a particular item that the associate may know is not in stock. Upon viewing the conversation, the inference engine may conclude that based on the customer service guidelines, the associate should suggest an alternative to the out of stock item that is available at the store. Upon drawing this conclusion, the protocol module 123 may update the advice provided on the HUD 210 to suggest that the associate offer advice on alternative products. The protocol module 123 may even transmit a query to the inventory module 117 to identify alternative products available and forward the results to augmented reality display device 131 to display on the HUD 210.

Embodiments of the augmented display module 119 may perform the function and task of connecting, interfacing, transmitting and receiving data between the augmented reality display device 131 and the customer interaction module 105 of the computer management system 103. Embodiments of the augmented display module 119 may control the stream of data provided to and received from the augmented reality display device. For example, the augmented display module 119 may distribute data to each of the appropriate augmented reality display devices making requests. The augmented display module may control the flow of location data for each customer's client device 143 located within the store, the customer data tied to each customer's profile 147, queries made to the inventory module 117 and mapping module 121 as well as the transmission and storage of audio or visual recordings maintained by the recording module 127.

Embodiments of the augmented display module 119 may further track the health and status of each augmented reality display device 131. For example, the augmented display module 119 may ensure that each augmented reality display device 131 is receiving an adequate power supply and is not suffering from a low battery, that the augmented reality display device 131 is maintaining a connection to network 120 and that the augmented reality display device 131 is appropriately located within the geofence created around a particular location. The augmented display module 119 may further troubleshoot errors, connectivity issues and errors in the display of the HUD, in order to correct these errors or determine whether maintenance on the augmented reality display device 131 may be needed.

In some embodiments of the system 100, the computer management system 103 may be equipped with a recording module 127. The recording module 127 may receive and store audio or visual recording created and saved by each of the on-board recording systems 141 of the augmented reality display devices. The recordings may be audio recordings recorded by a microphone, video recordings created by a camera device or a combination thereof. The recording module may organize and archive each of the recordings created by the augmented reality display devices 131. The recording module 127 may be queried by a user or administrator of the computer management system searching for recordings that may have been previously stored by the recording module 127, allowing for fast recall and loading of a particular recording by a specific augmented reality display device 131 at a particular moment in time. The recording module 127 may tag each recording with a date, time, device id number, and employee registered to the device at the time the recording occurred.

In some embodiments, the recordings archived by the recording module may be further used for evaluation and teaching purposes by an evaluation module 129. Embodiments of the evaluation module may use the recordings for both employee training and the evaluation of employee performance. The evaluation module 129 may parse through selected recordings and present the recordings to a user of the computer management system or transmit the recordings to a network accessible computer system for viewing purposes. When parsing through the selected recordings, the evaluation module 129 may compare the recordings with the customer service guidelines to ensure that the employee operating the augmented reality display device 131 followed the guidelines while interacting with customers. In some embodiments, the evaluation module 129 may evaluate the recordings for compliance with the customer service guidelines and assign a grade to the employee's performance. In other embodiments, the evaluation module 129 may flag a recording for review by the employer or user in charge of reviewing employee conduct.

In alternative embodiments, the evaluation module 129 may allow for user of the computer management system 103 to remotely access and view the augmented reality display device 131 through the perspective of the sales associate or other user operating the augmented reality display device. The evaluation module 129 may allow a user of the computer management system 103 to remotely stream the audio or visual data from the recording system 141 to the computer management system 103 or another selected computer system on the network 120, allowing for real time viewing of a sales associate's performance as the sales associate interacts with customers using the augmented reality display device 131.

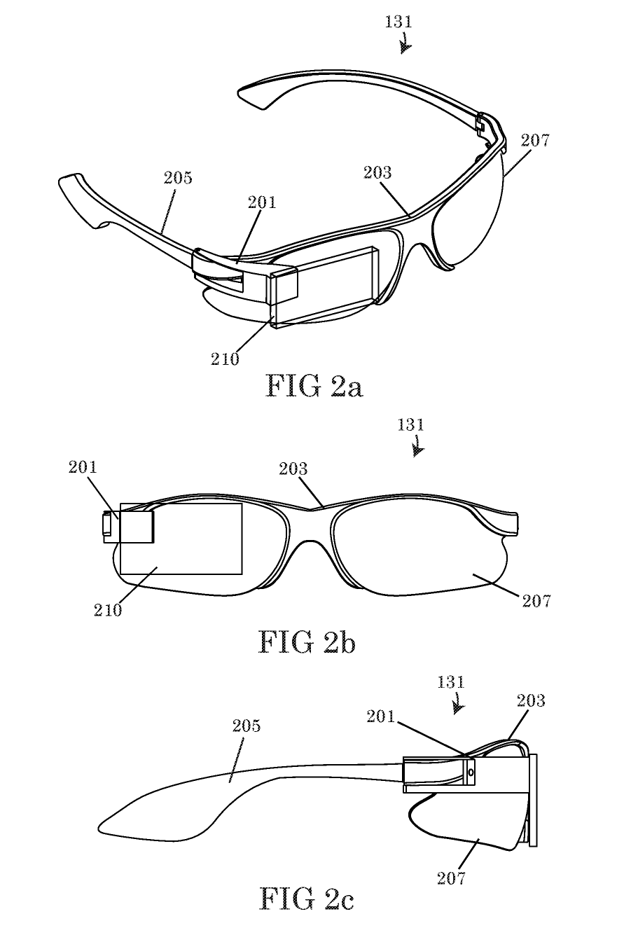

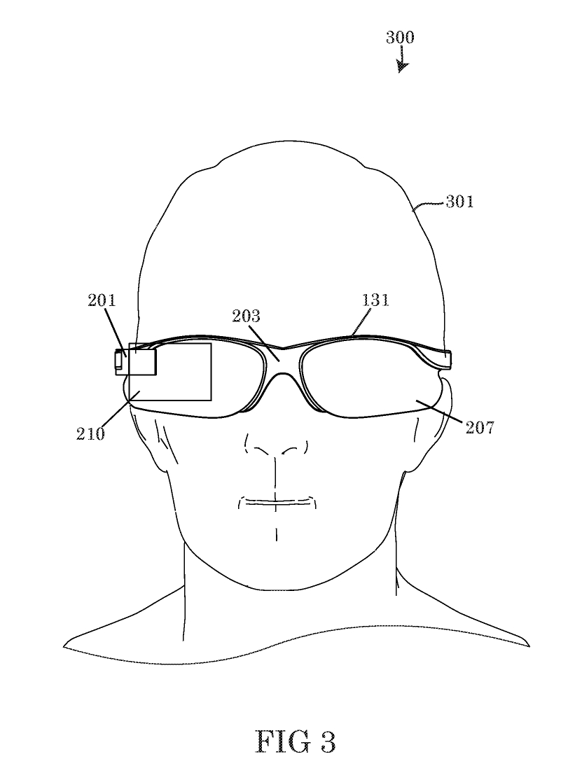

Referring to the drawings, FIG. 2a to FIG. 3 depict an embodiment of the augmented reality display device 131 which may be worn the user 301 of the augmented reality display device 131. As shown in the figures, the exemplary embodiment of the augmented reality display device 131 may be a pair of glasses comprising a frame 203, a pair of arms 205 each comprising a hinge and a pair of lenses 207. The frame 203, arms 205 and lenses may be constructed out of any material known by a person skilled in the art of glasses construction. For example, the underlying components of the glasses of the augmented reality display device 131 may be constructed out of various plastics, resins, rubbers, metals or metal alloys, etc. While the exemplary embodiment of the augmented reality display device 131 is depicted as glasses, this should in no way be limiting to the appearance that the augmented reality display device may take. Glasses are merely one example and the augmented reality display device may take other forms that comprise computer system housed within a housing 201 capable of overlaying images projected by the computer system onto an augmented reality HUD 210.

The electrical and computing components of the augmented reality display device 131 may be installed into a housing 201 attached to the frame 203 or arms 205 of the augmented reality display device 131. Within the interior of the housing 201, the computer system components integrated therein may include any of the components described by the computer system 800 of FIG. 8 discussed in detail below, including a processor 891, memory devices 894, 895 an input device 892 and an output device 893 (such as the viewable portion of the HUD 210). Additional specialized hardware and software components that may be integrated into the augmented reality display device 131 may include a display controller 131, HUD module 135, network interface controller 122, profile manager 139 and recording system 141.

The display controller 133 may be an integrated circuit that generates a video signal displaying the images, data and graphical interface onto the HUD 210. The display controller 133 may project the data received from the computer management system 103 including graphical text of the customer data 403, 405, inventory data, mapping data 407 and protocol data 413 generated using the customer service guidelines. The display controller 133 may operate in conjunction with the HUD module 133 which may be a software based component of the augmented reality display device 131. The HUD module 135 may be responsible for the visually relaying the graphical data of the user interface of the operating system of the augmented reality display device 131 or the programs loaded into the memory device of either the augmented reality display device or computer management system onto the physical glass or plastic background of the HUD 210.

Embodiments of the profile manager 139 may control the profile information and customer data received from the computer management system 103. Specifically, the profile manager may ensure that the correct customer data is properly viewed when in a viewable distance to the customer associated with the customer data. The profile manager 139 may control the customer data presentation on the HUD 210, ensuring that the data relevant to the customer within viewing distance of the augmented reality display device 131 is the data being presented. This may ensure that the HUD does not become overcrowded or display data that is irrelevant due to another customer being nearby, but out of sight from the augmented reality display device 131.

The recording system 141 of the augmented reality display device 131 may comprise an onboard camera device, microphone or combination thereof. The recording system may be manually activated by the user 301, remotely activated by the computer management system 103 (for example through the evaluation module 129) or automatically engaged as the user 301 engages a customer. In alternative embodiments, the recording system may be consistently running and recording data, streaming the recorded data over the network 120 and storing the recorded data for later playback in a data storage device 118 or network accessible repository 153.

### Method for Assisting Customers

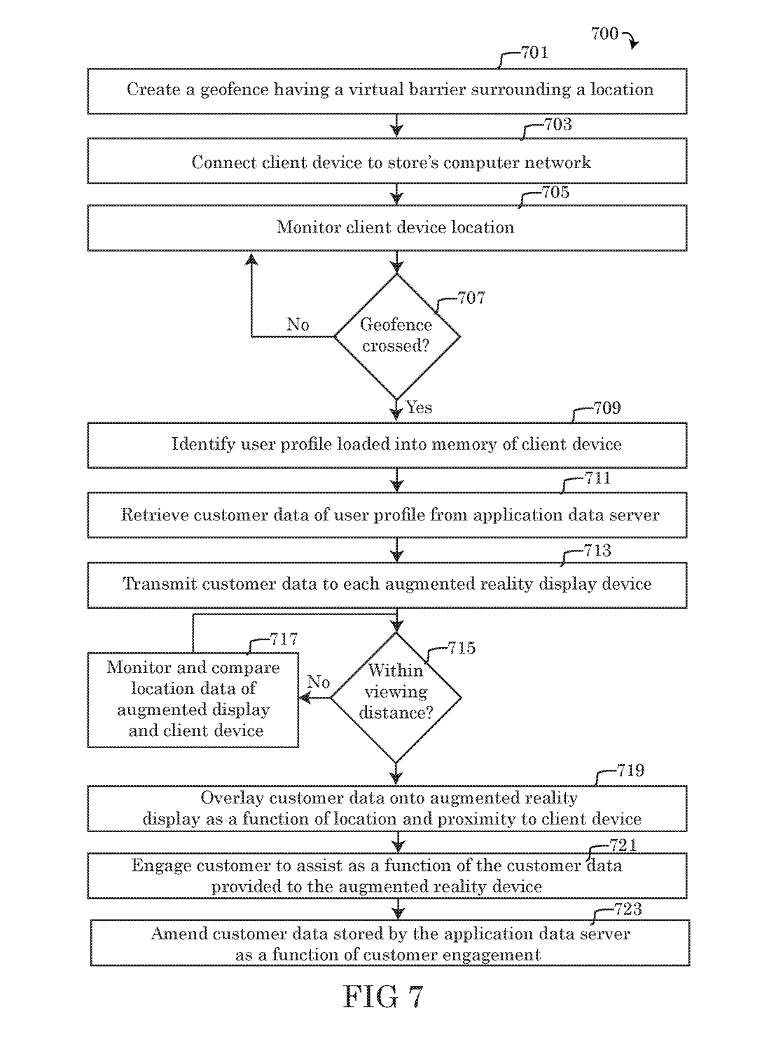

The drawing of FIG. 7 represents an embodiment 700 of an algorithm that may be implemented for assisting customers, in accordance with the systems described in FIGS. 1-6 using one or more computer systems defined generically in FIG. 8 below, and more specifically by the specific embodiments depicted in FIGS. 1-6. A person skilled in the art should recognize that the steps of the method described in FIG. 7 may not require all of the steps disclosed herein to be performed, nor does the algorithm of FIG. 7 necessarily require that all the steps be performed in the particular order presented. Variations of the method steps presented in FIG. 7 may be performed in a different order than presented by FIG. 7.

The algorithm 700 described in FIG. 7 may describe an embodiment for assisting customers using a combination of geofence technology, location tracking and augmented reality devices. The algorithm 700 may initiate in step 701 by creating a geofence having a virtual barrier surrounding a desired location. The geofence may be created, maintained and defined by the geofence creation tools integrated into the module 107 of the computer management system 103. Once created, the computer management system 103 may use the created geofence to monitor the activity of customers via each customer client device 143 that enters into the geofence.

In step 703, the network 120 maintaining the computer management system 103 and comprising the geofence of step 701 may connect the network to the client device 143 of the customer 401. Accordingly, as a function of the connectivity of the client device 143 to the network 120, the computer management system 103 may collect the location data of the client device 143 using the location module 109 as the client device 143 changes position while connected to the network, monitoring the client device's location relative to the geofence in step 705. In some embodiments, the tracking of the client device 143 may be performed using GPS while in alternative embodiments the location of the client device 143 may have its location tracked by the location module 109 using a wireless technique such as a Wi-Fi positioning system (WPS).

In step 707 of the algorithm 700, a determination may be made regarding whether or not the client device 143 of a customer has entered the geofence established by the geofence module 107. If, the virtual barrier of the geofence created in step 701 has not been entered by the client device 143, the algorithm 700 may simply continue to monitor the location of the client device 143. However, if the client device 143 has entered the geofence established in step 701, the algorithm 700 may proceed to step 709. In step 709, the computer management system 103 may identify the user profile 147 loaded into the memory of the client device 143. Based on the identification of the user profile, the profile module 115 may in step 711 connect to an application data server 149 storing customer data relating to the profile 147 loaded into the client device 143. The profile module 115 may retrieve customer data stored by the profile 147 and load the customer data into the memory device 114 of the computer management system 103.

Subsequently, after retrieving the customer data from the web or application server 149 for the identified profile 147, the customer data collected by the profile module may be transmitted to the augmented reality display device for display 131 onto a HUD 210 of the display device 131 when the view of the HUD 210 comes into a viewing distance of the customer 401 who generated the customer data of the profile 147. If, in step 715 it is determined that the user 301 of the augmented reality display device 131 is not within viewing distance of the customer/customer's client device 143, the computer management system 103 may continue to monitor and compare the locations of both the customer's client device 143 and the augmented reality display device 131 to determine when both devices are within viewing distance of one another.

Likewise, if in step 715, it is determined by the computer management system 103 that the location of the client device 143 is within viewing distance of the augmented reality display device 131, in step 719, the augmented reality display device 131 may overlay the customer data onto the HUD of the augmented reality display device 131 within the proximity of the customer, in a manner that may allow for the user 301 of the augmented reality display device 131 to simultaneously view the customer data on the HUD 210 and maintain eye contact with the customer 401.

In step 721, a user 301 of the augmented reality display device 131 may engage a customer in an attempt to assist the customer based on the customer data provided on the HUD 210 of the augmented reality display device. The user 301 may help the customer 401 fulfill orders, pickup orders, provide status updates, locate products and inventory. Upon successful completion of the assisting the customer, in step 723, the user 301 of the augmented reality display device 131 may amend the customer data stored by the application data server. The computer management system may acknowledge that a request for a service or product has been fulfilled by the user 301 or other store employee and the computer management system may update the customer data on the application data server 149 to properly reflect the assistance provided by the user 301.

### Computer System

Referring to the drawings, FIG. 8 illustrates a block diagram of a computer system 800 that may be included in the systems of FIGS. 1-6 and for implementing methods for assisting a customer as described in FIG. 7 and in accordance with the embodiments described in the present disclosure. The computer system 800 may generally comprise a processor 891, otherwise referred to as a central processing unit (CPU), an input device 892 coupled to the processor 891, an output device 893 coupled to the processor 891, and memory devices 894 and 895 each coupled to the processor 891. The input device 892, output device 893 and memory devices 894, 895 may each be coupled to the processor 891 via a bus. Processor 891 may perform computations and control the functions of computer 800, including executing instructions included in the computer code 897 for tools and programs for identifying errors in a multi-threaded application, in the manner prescribed by the embodiments of the disclosure using the systems of FIGS. 1-6, wherein the instructions of the computer code 897 may be executed by processor 891 via memory device 895. The computer code 897 may include software or program instructions that may implement one or more algorithms for implementing the methods for methods for assisting a customer, as described in detail above. The processor 891 executes the computer code 897. Processor 891 may include a single processing unit, or may be distributed across one or more processing units in one or more locations (e.g., on a client and server).

The memory device 894 may include input data 896. The input data 896 includes any inputs required by the computer code 897, 898. The output device 893 displays output from the computer code 897, 898. Either or both memory devices 894 and 895 may be used as a computer usable storage medium (or program storage device) having a computer readable program embodied therein and/or having other data stored therein, wherein the computer readable program comprises the computer code 897, 898. Generally, a computer program product (or, alternatively, an article of manufacture) of the computer system 800 may comprise said computer usable storage medium (or said program storage device).

Memory devices 894, 895 include any known computer readable storage medium, including those described in detail below. In one embodiment, cache memory elements of memory devices 894, 895 may provide temporary storage of at least some program code (e.g., computer code 897, 898) in order to reduce the number of times code must be retrieved from bulk storage while instructions of the computer code 897, 898 are executed. Moreover, similar to processor 891, memory devices 894, 895 may reside at a single physical location, including one or more types of data storage, or be distributed across a plurality of physical systems in various forms. Memory devices 894, 895 can include data distributed across, for example, a local area network (LAN) or a wide area network (WAN). Further, memory devices 894, 895 may include an operating system (not shown) and may include other systems not shown in the figures.

In some embodiments, rather than being stored and accessed from a hard drive, optical disc or other writeable, rewriteable, or removable hardware memory device 894, 895, stored computer program code 898 (e.g., including algorithms) may be stored on a static, non-removable, read-only storage medium such as a Read-Only Memory (ROM) device 899, or may be accessed by processor 891 directly from such a static, non-removable, read-only medium 899. Similarly, in some embodiments, stored computer program code 897 may be stored as computer-readable firmware 899, or may be accessed by processor 891 directly from such firmware 899, rather than from a more dynamic or removable hardware data-storage device 895, such as a hard drive or optical disc.

In some embodiments, the computer system 800 may further be coupled to an Input/output (I/O) interface 112 and a computer data storage unit (for example a data store, data mart or repository). An I/O interface 112 may include any system for exchanging information to or from an input device 892 or output device 893. The input device 892 may be, inter alia, a keyboard, joystick, trackball, touchpad, mouse, sensors, beacons, RFID tags, microphones, biometric input device, camera system, timer, etc. The output device 893 may be, inter alia, a printer, a plotter, a display device (such as a computer screen or monitor), a magnetic tape, a removable hard disk, a floppy disk, etc. The memory devices 894 and 895 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 800, and may include any type of transmission link, including electrical, optical, wireless, etc.

The I/O interface 112 may allow computer system 800 to store information (e.g., data or program instructions such as program code 897, 898) on and retrieve the information from a computer data storage unit (not shown). Computer data storage units include any known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider able to deploy or integrate computing infrastructure with respect identifying errors in a multi-threaded application. Thus, an embodiment of the present invention discloses a process for supporting computer infrastructure, where the process includes providing at least one support service for at least one of integrating, hosting, maintaining and deploying computer-readable code (e.g., program code 897, 898) in a computer system (e.g., computer 800) including one or more processor(s) 891, wherein the processor(s) carry out instructions contained in the computer code 897 causing the computer system to identify errors in an application. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for assisting a customer described in this application. Thus the present invention discloses a process for supporting, deploying and/or integrating computer infrastructure, integrating, hosting, maintaining, and deploying computer-readable code into the computer system 800, wherein the code in combination with the computer system 800 is capable of performing a method of identifying errors in a multi-threaded application.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for assisting a customer comprising the steps of:
detecting, by a computer system, a client device of the customer entering a geofence established by the computer system;
monitoring, by the computer system, a location of the computing device within the geofence;
retrieving, by the computer system, customer data from a user profile loaded in a memory device of the computing device;
overlaying, by the computer system, the customer data onto an augmented reality display device as a function of the location of the computing device being within a visible distance of the augmented reality display;
further overlaying, by the computer system, a customer service guide onto the augmented reality display device, guiding how to assist the customer within the visible distance of the augmented reality display device; and
dynamically updating, by the computer system, the customer data as a function of assisting the customer.

2. The method of claim 1, wherein the augmented reality display device is eyewear projecting the customer data onto a lens of the eyewear.

3. The method of claim 1, wherein the customer data is selected from the group consisting of the customer's name, pending orders, orders available for pickup, product preferences and shopping lists.

4. The method of claim 1, further comprising the step of:
amending, by the augmented reality display device, the customer data overlaid onto the augmented reality display device.

5. The method of claim 1, wherein the step of monitoring the location of the computing device is performed using a Wi-Fi positioning system (WPS) having a Wi-Fi access point positioned within the geofence.

6. The method of claim 1, wherein the user profile is created via a website or application and the website or application is remotely accessible to the computer system via a computer network.

7. The method of claim 1, further comprising the step of:
overlaying, by the computer system, a real time map onto the augmented reality display device, wherein the real time map indicates the location of the computing device or the augmented reality display device and a destination within the geofence.

8. The method of claim 2, wherein the customer service guide displays prompts indicating questions or actions for the employee to present to the customer during a customer interaction and wherein the prompts dynamically change as a function of the customer's responses during the customer interaction.

9. The method of claim 8, wherein the customer service guide directs the employee to inquire about pending orders, orders available for pickup, product preferences and shopping lists.

10. The method of claim 1, wherein the augmented reality display device records and monitors an employee performance during interactions with the customer.

11. A computer system comprising:
a processor;
a memory device coupled to the processor;
an augmented display device placed into wireless communication with the processor, the augmented display device having a heads up display; and
a computer readable storage device coupled to the processor, wherein the storage device contains program code executable by the processor via the memory device to implement a method for assisting a customer comprising the steps of:
detecting, by a computer system, a computing device entering a geofence established by the computer system;
monitoring, by the computer system, a location of the computing device within the geofence;
retrieving, by the computer system, customer data from a user profile loaded in a memory device of the computing device;
overlaying, by the computer system, the customer data onto an augmented reality display device as a function of the location of the computing device being within a visible distance of the augmented reality display;
further overlaying, by the computer system, a customer service guide onto the augmented reality display device, guiding how to assist the customer within the visible distance of the augmented display device; and
dynamically updating, by the computer system, the customer data as a function of assisting the customer.

12. The computer system of claim 11 wherein the employee viewing device is eyewear and the augmented reality display device is projected onto a lens of the eyewear.

13. The computer system of claim 11 wherein the customer data is selected from the group consisting of the customer's name, pending orders, orders available for pickup, product preferences and shopping lists.

14. The computer system of claim 11, wherein the method for assisting a customer further comprises:
amending, by the employee, the customer data overlaid onto the augmented reality display device.

15. The computer system of claim 11 wherein the step of monitoring the location of the computing device is performed using a Wi-Fi positioning system (WPS) having a Wi-Fi access point positioned within the geofence.

16. The computer system of claim 11, wherein the user profile is created via a website or application and the website or application is remotely accessible to the computer system via a computer network.

17. The computer system of claim 11, further comprising:
overlaying, by the computer system, a real time map onto the augmented reality display device, wherein the real time map indicates the location of the computing device or the augmented reality display device and a destination within the geofence.

18. The computer system of claim 12, wherein the customer service guide displays prompts indicating questions or actions for the employee to present to the customer during a customer interaction and wherein the prompts dynamically change as a function of the customer's responses during the customer interaction.

19. The computer system of claim 18, wherein the customer service guide directs the employee to inquire about pending orders, orders available for pickup, product preferences and shopping lists.

20. The computer system of claim 18, wherein the augmented reality display device records and monitors an employee performance during interactions with the customer.
